(19) United States
(12) Patent Application Publication
(10) Pub. No.: US 2024/0261191 A1
(43) Pub. Date: Aug. 8, 2024

(54) OPENING DETECTION SHEET, PACKAGING MATERIAL

(71) Applicants: UACJ CORPORATION, Tokyo (JP); UACJ FOIL CORPORATION, Tokyo (JP); KISCO LTD., Osaka (JP); UNI TAG LTD., Kumamoto (JP)

(72) Inventors: Hisaya KATO, Tokyo (JP); Tomoki TAKEDA, Tokyo (JP); Tomohiro MAEDA, Tokyo (JP); Yosuke TAKAGI, Tokyo (JP); Masaki TAKAISHI, Tokyo (JP); Daisuke ASADA, Kumamoto (JP); Shinji KANEKO, Kumamoto (JP)

(73) Assignees: UACJ CORPORATION, Tokyo (JP); UACJ FOIL CORPORATION, Tokyo (JP); KISCO LTD., Osaka (JP); UNI TAG LTD., Kumamoto (JP)

(21) Appl. No.: 18/566,598

(22) PCT Filed: Jun. 8, 2022
(86) PCT No.: PCT/JP2022/023078

§ 371 Date: Dec. 1, 2023

(30) Foreign Application Priority Data
Jun. 8, 2021 (JP) 2021-095629

(51) Int. Cl. A61J 7/04; A61J 1/03

(52) U.S. Cl. CPC A61J 7/0436; A61J 1/035; A61J 2205/60

(57) ABSTRACT

An opening detection sheet to be attached to a packaging material includes a metal layer, an IC, an insulating layer, and a first adhesive layer. The metal layer is releasable from the packaging material and includes a slit. The IC is mounted on the metal layer so as to cover at least a portion of the slit and for communicating with an external device. The insulating layer is disposed on an opposite side from the IC with respect to the metal layer. The first adhesive layer is bonded to the insulating layer on an opposite side from the metal layer so as to be bonded to the packaging material.

### TECHNICAL FIELD

The present technology relates to an opening detection sheet and a packaging material.

### BACKGROUND ART

In a packaging material (a press through package, for example) including a cavity portion that stores a tablet, a technology of detecting opening of the cavity portion has been known. One example of such a technology is disclosed in Patent Document 1. The packaging material described in Patent Document 1 includes a package body having a storing cavity (a receiving cavity) for storing a cavity item, a sheet for sealing the receiving cavity, a conducting wire formed on the sheet so as to pass above the sealed opening portion of the storing cavity, and a wireless communication device formed on the sheet so as to be connected to the conducting wire. The wireless communication device is provided for each storing cavity and transmits a signal including information which differs between before and after the opening of the storing cavity. This enhances reliability in sensing that a cavity item is taken out of a storing cavity and the opening of a storing cavity can be sensed even though the storing cavities are individually separated.

### PRIOR ART DOCUMENT

### Patent Document

Patent Document 1: WO 2019/069772

### Problem to be Solved by the Invention

However, in the packaging material described in Patent Document 1, electromagnetic wave from the conducting wire formed on the sheet and the wireless communication device may cause interference with the metal material included in the sheet. With the electromagnetic interference being caused, it is difficult to determine whether the signal transmitted by the wireless communication device differs between before and after the opening of the receiving cavity. The opening of the receiving cavity may not be detected correctly.

### SUMMARY OF THE INVENTION

The present technology was made in view of the above circumstances. An object is to enhance reliability of opening detection.

### Means for Solving the Problem

Means for solving the problem is described below.
<1> An opening detection sheet to be attached to a packaging material includes a metal layer, an IC, an insulating layer, and a first adhesive layer. The metal layer is releasable from the packaging material and includes a slit. The IC is mounted on the metal layer so as to cover at least a portion of the slit and is for communicating with an external device. The insulating layer is disposed on an opposite side from the IC with respect to the metal layer. The first adhesive layer is bonded to the insulating layer on an opposite side from the metal layer so as to be bonded to the packaging material.
<2> The opening detection sheet according to <1> further includes a second adhesive layer that has adhesive force greater than adhesive force of the first adhesive layer and is disposed between the insulating layer and the metal layer and bonded to the insulating layer.
<3> In the opening detection sheet according to <2>, the second adhesive layer is an adhesive agent or an adhesive tape that includes acryl-based material, urethane-based material, silicon-based material, or a rubber-based material.
<4> In the opening detection sheet according to any one of <1> to <3>, the first adhesive layer is an adhesive agent or an adhesive tape that includes acryl-based material, urethane-based material, silicon-based material, or a rubber-based material.
<5> In the opening detection sheet according to any one of <1> to <4>, adhesive force of the first adhesive layer with respect to the insulating layer is from 0.01 N/25 mm or greater and smaller than 10 N/25 mm.
<6> In the opening detection sheet according to any one of <1> to <5>, a thickness of the insulating layer is 1 mm or greater and 2 mm or smaller.
<7> The opening detection sheet according to any one of <1> to <6> further includes a release paper that is disposed on an opposite side from the insulating layer with respect to the first adhesive layer and to be released from the first adhesive layer before being attached to the packaging material such that the first adhesive layer is uncovered.
<8>A packaging material includes a storing portion storing an object, a cover that is a sheet and seals the storing portion, and the opening detection sheet according to any one of <1> to <6>. The opening detection sheet is attached to the cover.
<9> In the packaging material according to <8>, the cover includes an aluminum foil.
<10> In the packaging material according to <8> or
<9>, the storing portion includes storing portions, and the slit and the IC are provided for each of the storing portions.
<11> In the packaging material according to any one of <8> to <10>, the object can be taken out with the cover being pressed and broken.

### Effects of the Invention

According to the present technology, reliability of opening detection can be enhanced.

### BRIEF DESCRIPTION OF THE DRAWINGS

FIG. 1 is a cross-sectional view of an opening detection sheet according a first embodiment.

FIG. 2 is a plan view of a PTP to which the opening detection sheet is attached.

FIG. 3 is a cross-sectional view taken along A-A line in FIG. 2.

FIG. 4 is a cross-sectional view taken along B-B line in FIG. 2.

FIG. 5 is a magnified cross-sectional view illustrating a portion of FIG. 3 near an IC.

FIG. 6 is a perspective view of the PTP from which a metal layer is released.

FIG. 7 is a cross-sectional view illustrating the metal layer being released.

FIG. 8 illustrates Evaluation Experiment Result 1.

FIG. 9 is a plan view illustrating an outline of an opening detection sheet according to a second embodiment.

FIG. 10 is a plan view illustrating an outline of an opening detection sheet according to a third embodiment.

FIG. 11 illustrates Evaluation Experiment Result 2.

### MODES FOR CARRYING OUT THE INVENTION

### First Embodiment

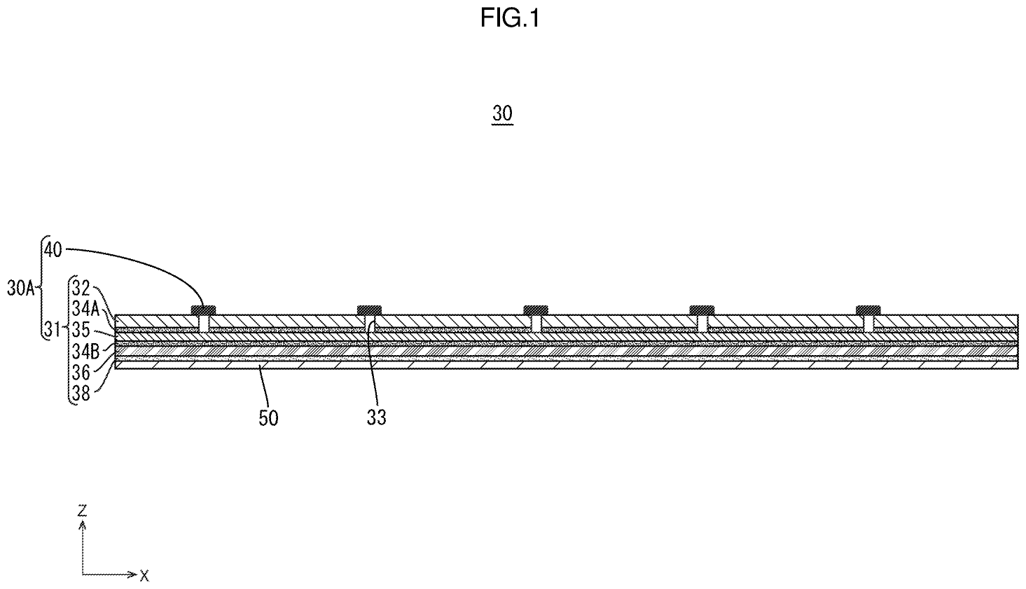

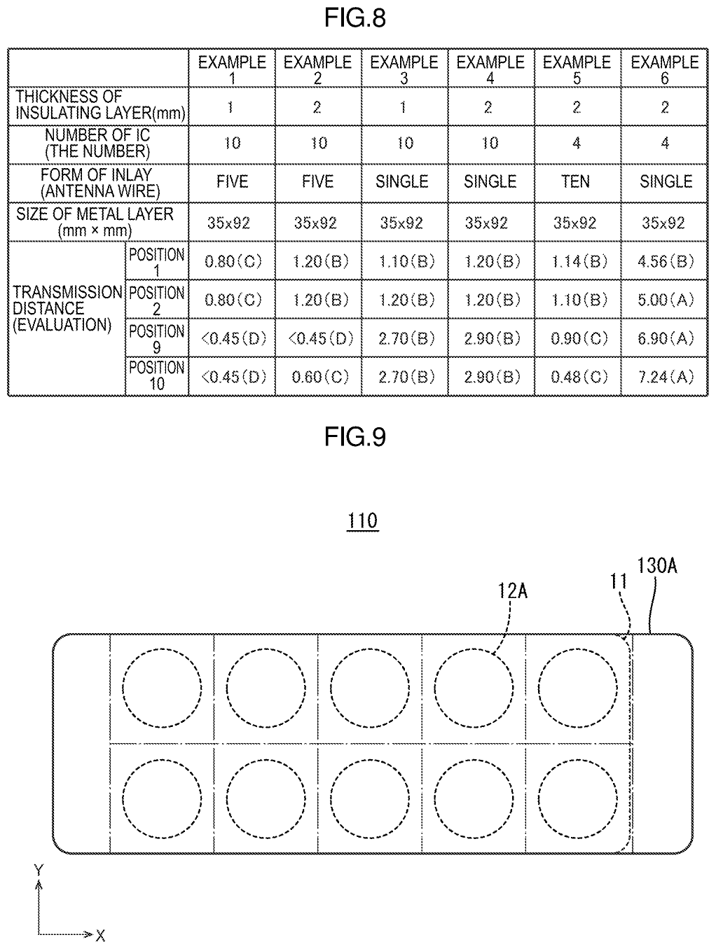

A first embodiment will be described with reference to FIGS. 1 to 8. In this embodiment section, an opening detection sheet 30A and a press through package 10 (PTP, an example of a packaging material) to which the opening detection sheet 30A is attached will be described. An X-axis, a Y-axis and a Z-axis may be present in each of the drawings except for Evaluation Experiment Results and each of the axial directions represents a direction represented in each drawing.

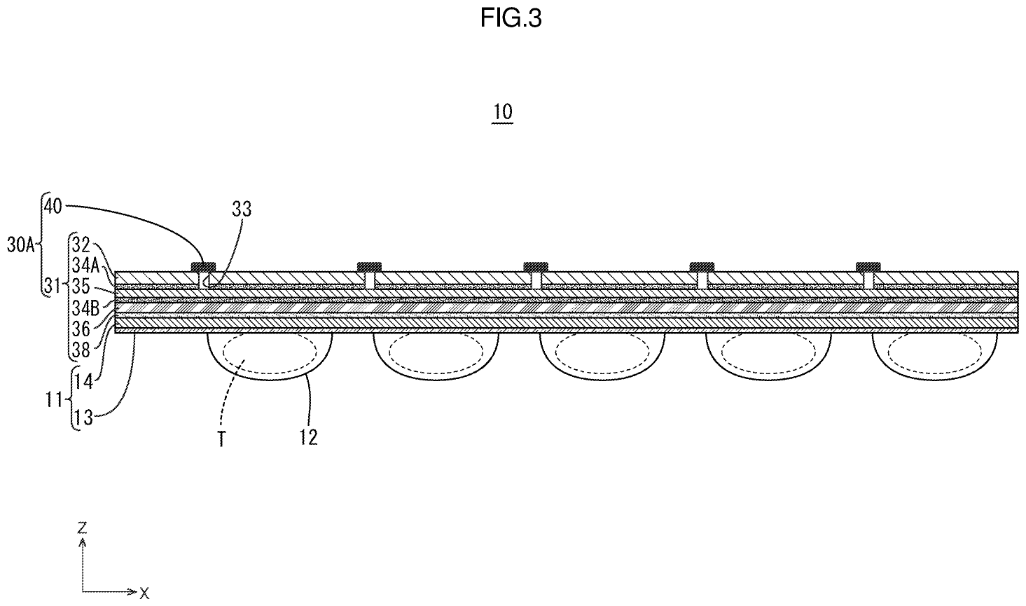

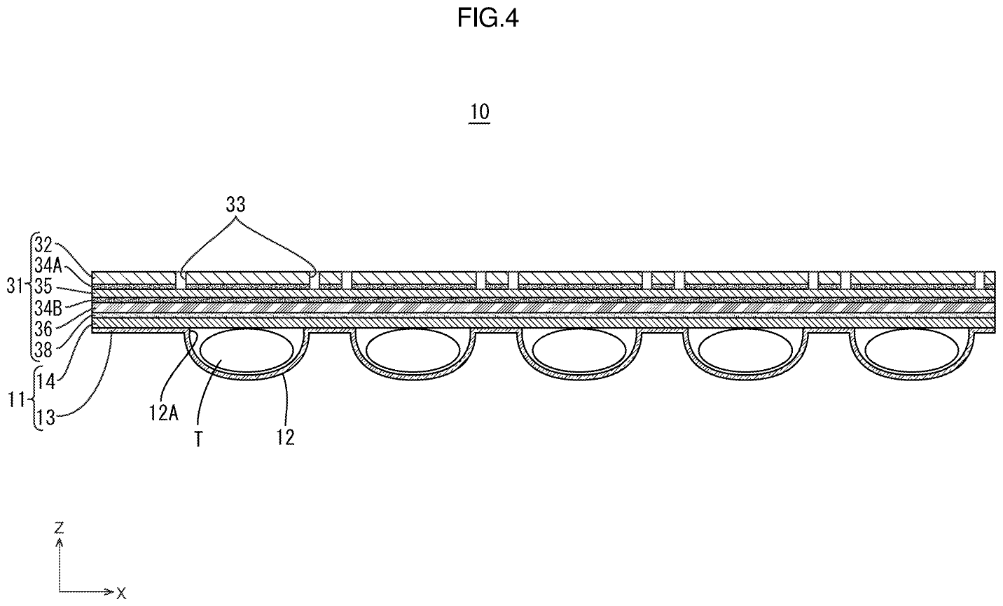

As illustrated in FIG. 1, an opening detection sheet 30 includes a composite member 31 that includes various kinds of layers disposed on top of each other, integrated circuits (ICs) 40 that are mounted on the composite member 31, and a release paper 50 that is attached to a surface of the composite member 31 opposite from a surface having the ICs 40. The release paper 50 is releasably attached to a low adhesive layer 38 (one example of a first adhesive layer) that includes a surface configured as a lower surface (the surface opposite from the surface having the ICs 40) of the composite member 31. The low adhesive layer 38 is uncovered by releasing the release paper 50 from the low adhesive layer 38. As illustrated in FIGS. 3 and 4, the uncovered low adhesive layer 38 is attached to the PTP 10 (more specifically, a cover 14 of a PTP body portion 11 which will be described later). In this description, the opening detection sheet from which the release paper 50 is released is represented by a reference sign of 30A and the opening detection sheet before the release paper 50 is released is represented by a reference sign of 30. With the release paper 50, the opening detection sheet 30 can be stored and distributed as a single object (a separate object) before being attached to the PTP body portion 11. The low adhesive layer 38 will be described in detail.

As illustrated in FIGS. 3 and 4, the PTP 10 includes the PTP body portion 11 that stores objects T (medical tablets) and the opening detection sheet 30A that is attached to the PTP body portion 11. The PTP body portion 11 includes a sheet-shaped container 13 and the cover 14. The sheet-shaped container 13 includes storing portions 12 in which the objects T are stored. The cover 14 is attached to cover openings 12A of the storing portions 12 and the storing portions 12 are sealed. The PTP body portion 11 has a parallelopiped (rectangular) plan view shape as a whole and the opening detection sheet 30A also has a plan view shape similar to that of the PTP body portion 11. The opening detection sheet 30A has a plan view size such that the whole PTP body portion 11 can be covered. In this embodiment, the opening detection sheet 30A and the PTP body portion 11 have a substantially same plan view size.

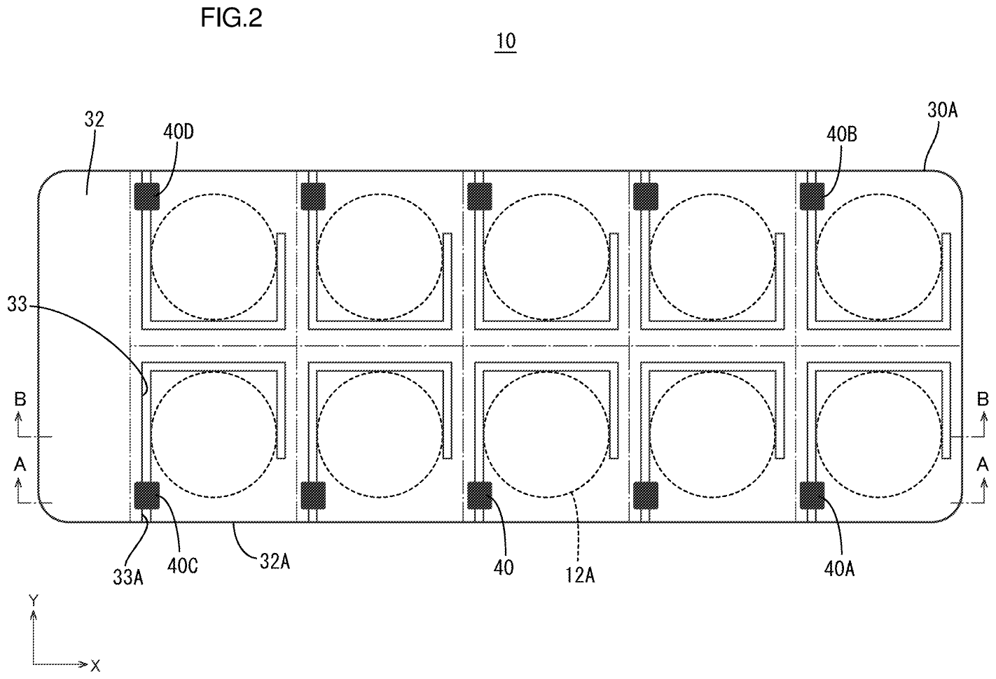

As illustrated in FIG. 4, the sheet-shaped container 13 includes a plurality of storing portions 12 that are recessed (project in a semispherical shape) to be away from the cover 14. Each storing portion 12 has a circular plan view shape following the shape of the object T as illustrated in FIG. 2. In this embodiment, five storing portions 12 are arranged at predefined intervals in an X-axis direction (a long side direction) and two storing portions 12 are arranged at predefined intervals in a Y-axis direction (a short side direction). A total of ten storing portions 12 are formed. The cover 14 is a flat sheet member and made of thin material that can be pressed to release the object. Portions of the cover 14 other than the portions covering the openings 12A are bonded to the sheet-shaped container 13. Known material for a PTP is used for the sheet-shaped container 13 and the cover 14. For example, resin material is used for the sheet-shaped container 13 and an aluminum foil is used for the cover 14.

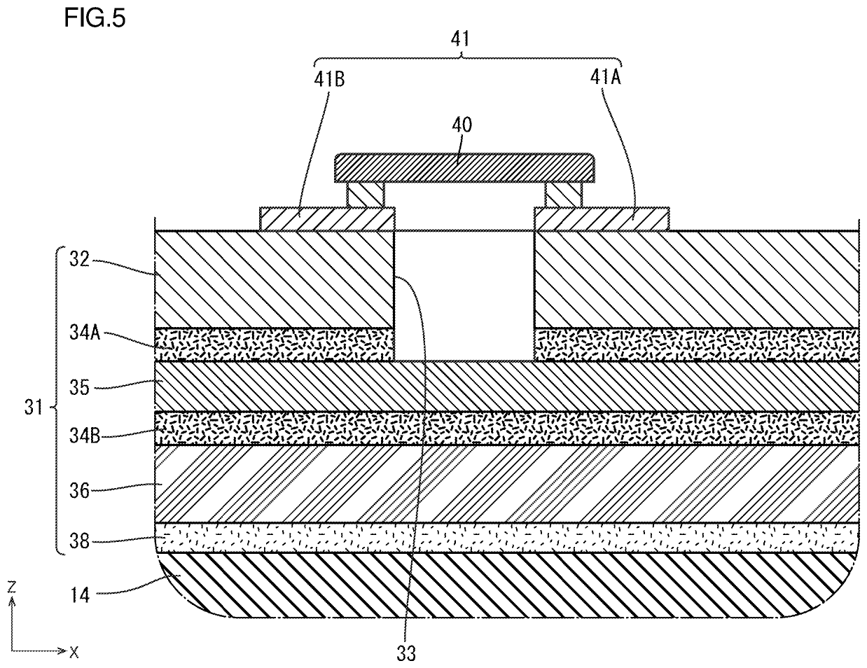

As illustrated in FIG. 5, the composite member 31 includes a metal layer 32, an upper high adhesive layer 34A, a base layer 35, a lower high adhesive layer 34B (one example of a second adhesive layer), an insulating layer 36, and the low adhesive layer 38 that are disposed on top of each other. The metal layer 32 is an aluminum layer, for example, and is an antenna wire layer including a wire configured as an antenna. The antenna wire may be formed in a unitary form in an entire area of the metal layer 32 or multiple antenna wires may be formed in divided areas of the metal layer 32, respectively. With the antenna wires being formed in the respective divided areas, as illustrated with one dot chain lines in FIG. 2, the area of the metal layer 32 may be divided into rectangular sections and the antenna wire may be formed in each of the divided sections (for example, ten sections in this embodiment). Or, for example, the area of the metal layer 32 may be divided into five sections each of which includes two storing portions 12 arranged in the short side direction and the antenna wire may be formed in each of the five divided sections.

The PTP 10 is configured to perform wireless communication with an external communication device via the metal layer 32 (the antenna wire layer) and the ICs 40. For example, the ICs 40 and the antenna included in the metal layer 32 are configured to receive a signal transmitted by the external communication device and send a signal to the external communication device in response to the receiving of the signal. A near field communication technology such as radio-frequency identification may be used as a wireless communication method; however, the communication method is not particularly limited.

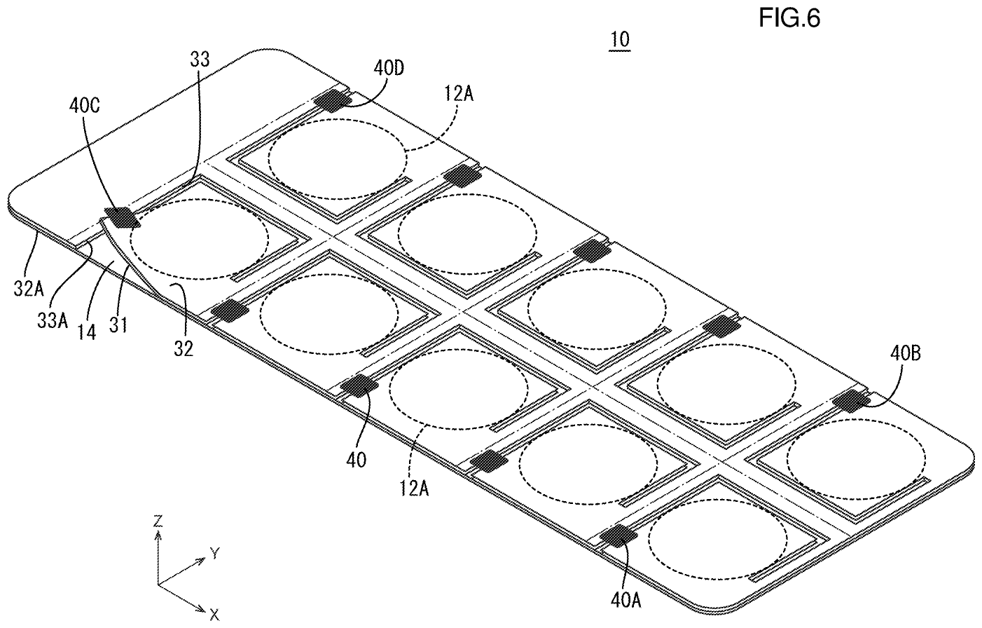

As illustrated in FIG. 2, the metal layer 32 and the upper high adhesive layer 34A include a plurality of slits 33 (ten slits 33 in this embodiment) having about a J-shaped plan view shape. One slit 33 is formed for each storing portion 12. Each slit 33 extends in a J-shape to surround a portion of an outer edge (an opening edge of the opening 12A) of the storing portion 12. As illustrated in FIG. 4, the slit 33 is a hole that extends through the metal layer 32 and the upper high adhesive layer 34A. One end portion 33A of the slit 33 that extends in the J-shape is disposed at an outer edge 32A of the metal layer 32. With such a configuration, as illustrated in FIG. 6, a user can use the one end portion 33A as a starting point of releasing and release the metal layer 32 (and the insulating layer 36 attached thereto) from the one end portion 33A side along the shape of the slit 33. The plan view shape of the slit 33 may not necessarily be the J-shape. The slit 33 may extend in any shape such as L-shape and I-shape as long as the slit 33 extends from the one end portion 33A along a portion of the outer edge of the storing portion 12. With such a shape, after releasing the metal layer 32 and the insulating layer 36 from the one end portion 33A side along the slit 33, a user can press and break the cover 14 that covers the opening 12A of the storing portion 12.

As illustrated in FIG. 5, the base layer 35 is bonded to the metal layer 32 with the upper high adhesive layer 34A and supports the metal layer 32. With the base layer 35, shape stability of the metal layer 32 and heat resistant property of the metal layer 32 during the manufacturing processing can be improved. The base layer 35 is made of resin material having insulating property. The thickness of the base layer 35 is (for example, from about 25 μm to 50 μm) much smaller than that of the insulating layer 36. Specifically, a PET (polyethylene terephthalate) film may be used as the base layer 35.

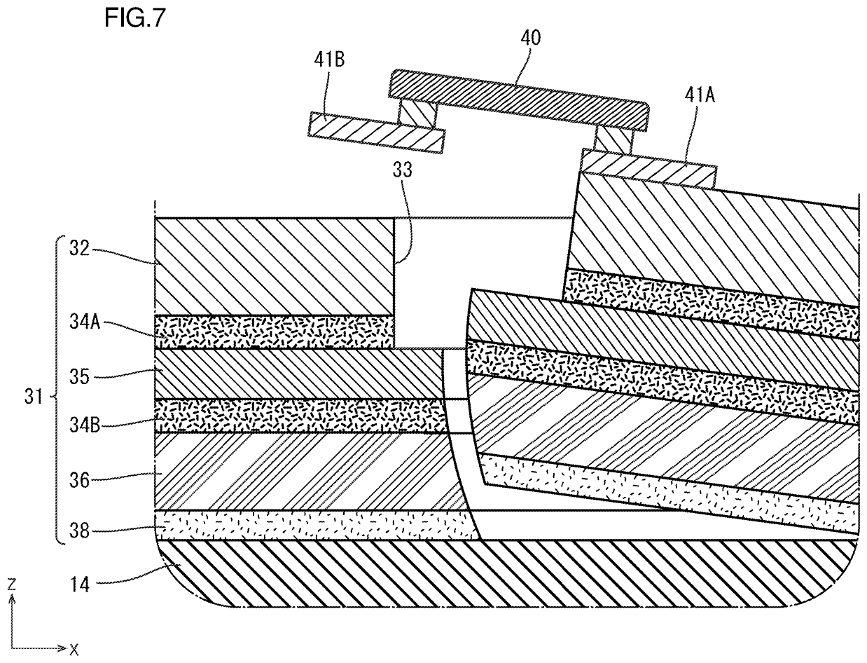

As illustrated in FIG. 5, the upper high adhesive layer 34A is between the metal layer 32 and the base layer 35 to bond the metal layer 32 and the base layer 35 firmly. The lower high adhesive layer 34B is between the base layer 35 and the insulating layer 36 to bond the base layer 35 and the insulating layer 36 firmly. The upper high adhesive layer 34A and the lower high adhesive layer 34B are adhesive agent or adhesive tapes made of acryl-based material, urethane-based material, silicon-based material, or rubber-based material. The upper high adhesive layer 34A and the lower high adhesive layer 34B have adhesive force greater than that of the low adhesive layer 38. Specifically, the adhesive force (JIS Z 0237 (2000)) of the upper high adhesive layer 34A and the lower high adhesive layer 34B with respect to the insulating layer 36 is 10 N/25 mm or greater. Accordingly, when the metal layer 32 is released, the base layer 35 and the insulating layer 36 that are firmly bonded to the metal layer 32 can be released together with the metal layer 32 along the slit 33 (FIG. 7). A cutting line of perforations or a slit may be formed in the base layer 35 and the insulating layer 36 to overlap the slit 33 in a plan view such that the base layer 35 and the insulation layer 36 can be broken easily.

As illustrated in FIG. 5, the insulating layer 36 and the cover 14 of the PTP body portion 11 are releasably bonded to each other with the low adhesive layer 38. The opening detection sheet 30A is bonded to the PTP body portion 11 by bonding the low adhesive layer 38 to a sheet surface of the cover 14. As illustrated in FIG. 1, the insulating layer 36 and the release paper 50 are releasably bonded to each other with the low adhesive layer 38 before the opening detection sheet 30A is bonded to the PTP body portion 11. The low adhesive layer 38 is adhesive agent or an adhesive tape made of acryl-based material, urethane-based material, silicon-based material, or rubber-based material. The low adhesive layer 38 has adhesive force smaller than that of the upper high adhesive layer 34A and the lower high adhesive layer 34B. Specifically, the adhesive force (JIS Z 0237 (2000)) of the low adhesive layer 38 with respect to the insulating layer 36 is 0.01 N/25 mm or greater and smaller than 10 N/25 mm.

As illustrated in FIG. 5, the insulating layer 36 is disposed on an opposite side from the IC 40 with respect to the metal layer 32. The insulating layer 36 is bonded to the base layer 35 with the lower high adhesive layer 34B. The insulating layer 36 is between the cover 14 (an aluminum foil) of the PTP body portion 11 and each of the metal layer 32 (an antenna wire layer) and the ICs 40 mounted on the metal layer 32 and suppresses the electromagnetic interference that may be caused therebetween. A known resin sheet may be used for the insulating layer 36. The insulating layer may be preferably made of material having small relative permittivity & and preferably have a predefined thickness or greater to increase the transmission distance.

A relation of the relative permittivity & and the thickness d of the insulating layer 36 and the transmission distance will be described. The transmission distance of the PTP 10 increases as the impedance Z₁₀ increases. The impedance Z₁₀ is represented by the following formula with using electrostatic capacitance C and a frequency f of wireless communication.

$${Z}_{10} = 1 / ( 2 π f \times C ) \qquad ( formula 1 )$$

The electrostatic capacitance C of the PTP 10 is close to that of electrically conductive flat plates (the metal layer 32 and the cover 14) that are disposed opposite each other with sandwiching the insulating layer 36 therebetween. The electrostatic capacitance C of the PTP 10 is represented by the following formula.

$$C = S \times ε \times {ε}_{0} / d \qquad ( formula 2 )$$

S: an area of the opening detection sheet 30A
ε: relative permittivity of the insulating layer 36
ε₀: permittivity of vacuum
d: thickness of the insulating layer 36

With the communication is performed with the same frequency f, the impedance Z₁₀ of the PTP 10 increases as the relative permittivity & of the insulating layer 36 decreases and the impedance Z₁₀ of the PTP 10 increases as the thickness d increases according to (the formula 1) and (the formula 2). Accordingly, the transmission distance of the PTP 10 increases as the relative permittivity & of the insulating layer 36 decreases and the transmission distance of the PTP 10 increases as the thickness d increases. With using a foaming polyethylene terephthalate (PET) sheet having a foaming ratio of two times as the insulating layer 36, the relative permittivity & is reduced to about 1.58. A resin sheet made of polystyrene, polyurethane, polypropylene, or polyimide each of which has relative permittivity & of 1.58 or smaller may be used as the insulating layer 36. The thickness d of the insulating layer 36 is preferably 1 mm or greater in view of the transmission distance as will be described in Evaluation Experiment Result 1. However, with the insulating layer 36 being too thick, the metal layer 32 and the insulating layer 36 are unlikely to be released along the slit 33 when a user releases them. In view of both of the transmission distance and the releasability, the thickness d of the insulating layer 36 is preferably 1 mm or greater and 2 mm or smaller.

As illustrated in FIG. 2, the IC 40 is an IC chip having a rectangular parallelepiped shape. The ICs 40 (ten ICs in this embodiment) are mounted and one IC 40 is mounted corresponding to each slit 33 (each storing portion 12). The IC 40 is mounted on the metal layer 32 so as to cover a portion of the slit 33 that is closer to the one end portion 33A. As illustrated in FIG. 5, a terminal 41 of each IC 40 is connected to a wire that is configured as the antenna formed in the metal layer 32. One of the terminals is a terminal 41A (a positive terminal to which a positive electrode is applied) and another one of the terminals is a terminal 41B (a negative terminal to which a negative electrode is applied). The terminal 41A is opposite the terminal 41B with sandwiching the slit 33 therebetween.

With the metal layer 32 and the insulating layer 36 being released along the slit 33, as illustrated in FIG. 7, a portion of the metal layer 32 where the positive terminal 41A is mounted is separated from the PTP 10 side and the negative terminal 41B is pulled upward and separated from the metal layer 32. As a result, the IC 40 is disconnected from the antenna wire in the metal layer 32 and becomes in a non-conductive state and no communication is possible between the IC 40 and the external communication device. The external communication device does not receive a response (communication) signal in response to a transmission signal therefrom.

With the metal layer 32 and the insulating layer 36 being released, the storing portion 12 that has been covered with the released metal layer 32 and the insulating layer 36 can be opened. More specifically, with a user pressing the object T stored in the storing portion toward the cover 14 and breaking the cover 14 after releasing the metal layer 32 and the insulating layer 36, the PTP body portion 11 is opened. Thus, the metal layer 32 and the insulating layer 36 are released first and thereafter, the cover 14 is pressed and broken to open the PTP body portion 11. Such a PTP 10 is a peel-push type packaging material.

With the above configuration, if the external communication device receives a response signal from the IC 40 in response to a transmission signal therefrom, the external communication device determines that the storing portion 12 including the IC 40 is not opened. On the other hand, if the response signal is not received, it is determined that the storing portion 12 is opened. The external communication device is configured to determine whether the external communication device receives a predefined signal before and after the opening to determine whether the storing portion 12 is opened or not. The external communication device is not configured to determine whether the storing portion is opened or not by receiving different signals before and after the opening. Therefore, even if an S/N ratio of the signal (electromagnetic wave) that is transmitted from the IC 40 and the antenna included in the metal layer 32 may be lowered due to the electromagnetic interference, the opening can be reliably determined. In the opening detection sheet 30A, with the insulating layer 36, the electromagnetic interference with the cover 14 (aluminum foil) of the PTP body portion 11 is less likely to be caused. Thus, in the PTP 10, the electromagnetic interference with the PTP body portion 11 is suppressed by the insulating layer 36 and the PTP 10 is configured such that the opening is reliably determined even if the S/N ratio is lowered due to the electromagnetic interference. Therefore, reliability of detecting the opening is improved.

### Evaluation Experiment 1

To evaluate the transmission performance of the PTP 10, Evaluation Experiment 1 was performed. In Evaluation Experiment 1, the transmission distances were evaluated for evaluation samples (Examples 1 to 6) each including a simple configuration similar to the configuration of the PTP 10.

### <Conditions>

A planar size of the opening detection sheet 30A: 35 mm×92 mm
The metal layer 32: a copper foil or an aluminum foil
The upper high adhesive layer 34A and the lower high adhesive layer 34B: acrylic adhesive agent
The insulating layer 36: a foaming PET sheet (relative permittivity ε=about 1.58)
Thickness d of the insulating layer 36: 1 mm or 2 mm
The PTP body portion 11 and the low adhesive layer 38: aluminum seal
The IC 40: RFID IC
The number of ICs 40: Ten in Examples 1 to 4 as illustrated in FIG. 2, four in Examples 5 and 6 including an IC 40A (a position 1), an IC 40B (a position 2), an IC 40C (a position 9), and an IC 40D (a position 10) corresponding to the storing portions 12 on right and left edge portions with respect to the long side direction in FIG. 2
A measurement device: a RFID tester (Tagformance lite made by Voyantic), linear polarization antenna for a measurement antenna
Measurement environment: communication with a distance of 45 cm from the measurement antenna in an anechoic box (a smallest measurement distance=0.45 m)
Measurement: designating an EPC code as an identification code and measuring with command Query
Method of calculating transmission distance: based on a smallest output obtained in response to a reply, calculating a communication distance (transmission distance) when the output of EIRP (equivalent isotropically radiated power) is 3.28 W

### <Method of Evaluating Transmission Distance>

Evaluation samples (Examples 1, 2, and 5) each of which includes multiple antenna wires in the divided sections of the metal layer 32 and evaluation samples (Examples 3, 4, and 6) each of which includes an antenna wire in an entire area of the metal layer 32 are provided and evaluated. Example 5 includes ten antenna wires corresponding to the number of storing portions 12 (ten) and each of Examples 1 and 2 includes five antenna wires each corresponding to every two of ten storing portions 12 (two storing portions 12 arranged in the short side direction in FIG. 2). For each Example, the transmission distance from each of the IC 40A (the position 1), the IC 40B (the position 2), the IC 40C (the position 9), and the IC 40D (the position 10) was evaluated. The evaluation of the transmission distance includes four grades from A to D. With the transmission distance range being 5 m or more, the evaluation is A (very good). With the transmission distance range being 1 m or more and less than 5 m, the evaluation is B (good). With the transmission distance range being 0.45 m or more and less than 1 m, the evaluation is C (OK). With the transmission distance range being less than 0.45 m, the evaluation is D (failed).

### <Evaluation Results of Transmission Distances>

The evaluation results of Evaluation Experiment 1 will be described. As illustrated in FIG. 6, the transmission distances vary according to the positions (IC 40A (the position 1), IC 40B (the position 2), IC 40C (the position 9), IC 40D (the position 10) where the ICs 40 are mounted. It was confirmed that the evaluation of C or better evaluation were obtained in all of Examples 1 to 6. In Example 1 of the worst evaluation, the transmission distance from each of the positions 1 and 2 is 0.8 m and it was confirmed that Example 1 can be properly used. With comparing Examples 1 and 2 and Examples 3 and 4, it was confirmed that the transmission distance is greater in Examples (Examples 2 and 4) having 2 mm thickness of the insulating layer 36 than in Examples (Examples 1 and 3) having 1 mm thickness of the insulating layer 36. The results match the mechanism that is previously described using (the formula 1) and (the formula 2). Therefore, suppose that Comparative Example 1 has the same configuration as that of Example 1 except for the thickness of the insulating layer 36, which is less than 1 mm, the transmission distance from each of the positions 1 and 2 in Comparative Example 1 may be smaller than 0.8 m and the evaluation may be D. Therefore, in view of the transmission performance, the thickness of the insulating layer 36 is preferably 1 mm or more.

With comparing Examples 1 and 3 and Examples 2 and 4 and Examples 5 and 6, it was confirmed that the transmission distance is greater in Examples (Examples 3, 4, and 6) including a single antenna wire than in Examples (Examples 1, 2, and 5) including separated antenna wires. The transmission distance may be greater in Examples including a single antenna because a large antenna wire can be used. However, in Examples including a single antenna, if the metal layer 32 is released along the slit 33 in any one of the positions 1, 2, 9, 10 and one of the ICs 40A, 40B, 40C, 40D, which corresponds to the one of the positions, is disconnected, the disconnection of one IC easily affects other ICs. In Examples including a single antenna, the frequency adjustment is difficult since large frequency influence is caused between the ICs at the adjacent positions (for example, the positions 1 and 2, the positions 9 and 10). Therefore, it was confirmed that Examples including separated antenna wires were superior in transmission stability to Examples including a single wire.

### Second Embodiment, Third Embodiment

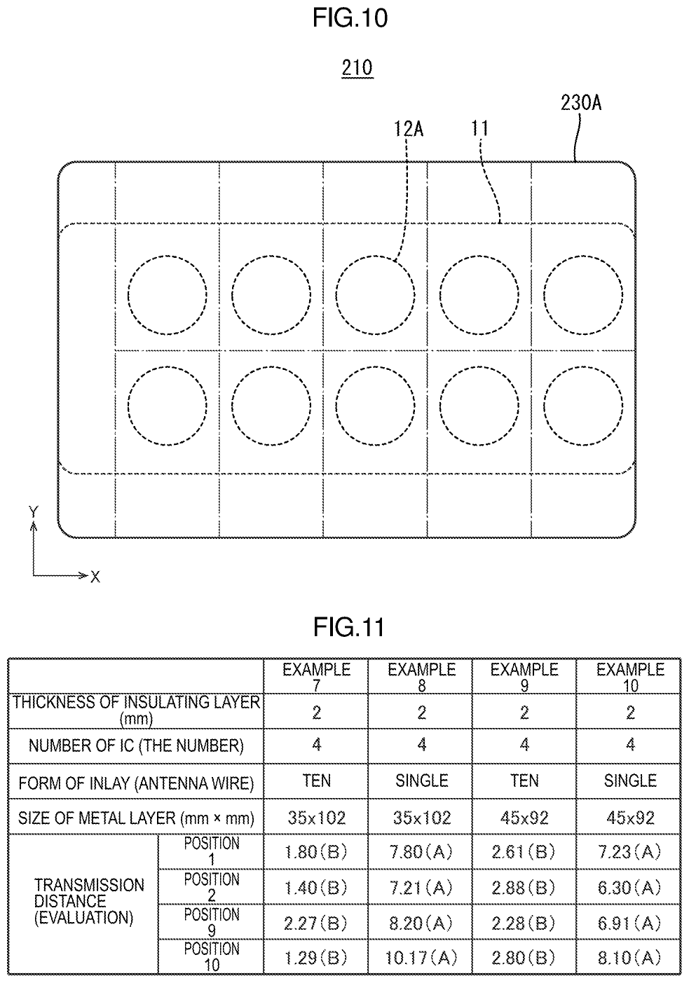

A PTP 110 according to a second embodiment and a PTP 210 according to a third embodiment will be described with reference to FIGS. 9 to 11. As illustrated in FIGS. 9 and 10, the PTPs 110, 210 differ from the first embodiment in that the planar size of opening detection sheets 130A, 230A is greater than that of the PTP body portion 11. In the second and third embodiments, the configurations, operations, and effects that are similar to those of the first embodiment will not be described. In FIGS. 9 and 10, the components (the slits 33, the ICs 40) of the opening detection sheets 130A, 230A are not illustrated such that the outlines of the opening detection sheets 130A, 230A can be easily seen. The basic configuration of the second and third embodiments is similar to that of the first embodiment.

As illustrated in FIG. 9, the opening detection sheet 130A of the second embodiment has a long-side dimension that is greater than that of the PTP body portion 11 by 10 mm. The planar size of the opening detection sheet 130A is 35 mm×102 mm. The opening detection sheet 130A has a length in the long side direction that extends further from the right end of the opening detection sheet 30A of the first embodiment in the long side direction (+Y-axis direction) by 10 mm. Namely, each of the layers included in the opening detection sheet 130A has a long-side outline dimension that is greater than that of the first embodiment by 10 mm. Other configurations of the opening detection sheet 130A (for example, the number of the slits 33 and the intervals between the slits 33) are similar to those of the first embodiment.

As illustrated in FIG. 10, the opening detection sheet 230A of the third embodiment has a short-side dimension that is greater than that of the PTP body portion 11 by 10 mm. The planar size of the opening detection sheet 230A is 45 mm 90 mm. The opening detection sheet 230A has a length in the short side direction that extends further from each of the upper and lower ends of the opening detection sheet 30A of the first embodiment in the short side direction (+X-axis direction, −X-axis direction) by 5 mm. Namely, each of the layers included in the opening detection sheet 230A has a short-side outline dimension that is greater than that of the first embodiment by 10 mm. Other configurations of the opening detection sheet 230A (for example, the number of the slits 33 and the intervals between the slits 33) are similar to those of the first embodiment.

With the planar size of the opening detection sheets 130A, 230A increasing, the transmission distance can be increased as will be described in Evaluation Experimental Result 2, which will be described later. The increase of the transmission distance may be achieved since the area S (at least the area of the metal layer 32) is increased according to the mechanism previously described by (the formula 1) and (the formula 2) and the dimension of the antenna wire in the metal layer 32 can be increased.

### Evaluation Experiment 2

To evaluate the transmission performance of the PTPs 110, 210, Evaluation Experiment 2 was performed. In Evaluation Experiment 2, the transmission distances were evaluated for evaluation samples (Examples 7 to 10) each including a simple configuration similar to the configuration of the PTPs 110, 210.

### <Conditions>

A planar size of the opening detection sheet 130A: 35 mm×102 mm
A planar size of the opening detection sheet 230A: 45 mm×92 mm
The metal layer 32: same as that of Evaluation Experiment 1 other than the planar size
The upper high adhesive layer 34A and the lower high adhesive layer 34B: same as those of Evaluation Experiment 1 other than the planar size
The insulating layer 36: same as that of Evaluation Experiment 1 other than the planar size
Thickness d of the insulating layer 36: 2 mm
The PTP body portion 11 and the low adhesive layer 38: same as those of Evaluation Experiment 1
The IC 40: same as those of Evaluation Experiment 1
The number of ICs 40: four ICs including the IC 40A (the position 1), the IC 40B (the position 2), the IC 40C (the position 9), and the IC 40D (the position 10) corresponding to the storing portions 12 in right and left edge portions with respect to the long side direction in FIG. 2
A measurement device: same as that of Evaluation Experiment 1
Measurement environment: same as that of Evaluation Experiment 1
Measurement: same as that of Evaluation Experiment 1
Method of calculating transmission distance: same as that of Evaluation Experiment 1

### <Method of Evaluating Transmission Distance>

Evaluation samples (Examples 7 and 9) each of which includes multiple antenna wires in the divided sections of the metal layer 32 and evaluation samples (Examples 8 and 10) each of which includes an antenna wire in an entire area of the metal layer 32 are provided and evaluated. Each of Examples 7 and 9 includes ten antenna wires corresponding to the number of storing portions 12 (ten). For each Example, the transmission distance from each of the IC 40A (the position 1), the IC 40B (the position 2), the IC 40C (the position 9), and the IC 40D (the position 10) was evaluated similar to Evaluation Experiment 1. The evaluation of the transmission distance includes four grades from A to D.

### <Evaluation Results of Transmission Distances>

The evaluation results of Evaluation Experiment 2 will be described. As illustrated in FIG. 11, the transmission distances vary according to the positions (the positions 1, 2, 9, 10) where the ICs 40 are mounted. It was confirmed that the evaluation of B or better evaluation were obtained in all of Examples 7 to 10 and all of Examples 7 to 10 can be properly used. With comparing Examples 7 and 8 and Examples 9 and 10, similar to Evaluation Experiment Result 1, it was confirmed that the transmission distance is greater in Examples (Examples 8 and 10) including a single antenna wire than in Examples (Examples 7 and 9) including separated antenna wires. The transmission distance may be greater in Examples including a single antenna because a large antenna wire can be used. However, in Examples including a single antenna, if a metal layer 132, 232 is released along the slit 33 in any one of the positions 1, 2, 9, 10 and one of the ICs 40A, 40B, 40C, 40D, which corresponds to the one of the positions, is disconnected, the disconnection of one IC easily affects other ICs. In Examples including a single antenna, the frequency adjustment is difficult since large frequency influence is caused between the ICs at the adjacent positions (for example, the positions 1 and 2, the positions 9 and 10). Therefore, it was confirmed that Examples including separated antenna wires were superior in transmission stability to Examples including a single wire.

With comparing Examples 7, 9 and Example 5 of Evaluation Experiment Result 1, it was confirmed that the transmission distance is greater in the second embodiment (Example 7) and the third embodiment (Example 9) than that of Example 5. Furthermore, with comparing Examples 8, 10 and Example 6 of Evaluation Experiment Result 1, it was confirmed that the transmission distance is greater in the second embodiment (Example 8) and the third embodiment (Example 10) than that of Example 5. From the above, it was confirmed that the transmission distance can be increased by increasing a planar size of the opening detection sheets 130A, 230A.

### Other Embodiments

The present invention is not limited to the embodiments described above with reference to the drawings. For example, the following embodiments may be included in the technical scope of the present invention.
(1) Each of the layers included in each of the opening detection sheets 130A, 230A may not necessarily have a planar size that is greater than that of the PTP body portion 11. The effects of the increase in the transmission distance verified by Evaluation Experiment Result 2 can be obtained when the planar size of at least the metal layer 32 is greater than that of the PTP body portion 11.
(2) The shapes of the PTPs 10, 110, 210, the number of storing portions 12, and the intervals between the storing portions 12 described in the drawings are examples and may be varied as appropriate. The PTP may be configured to be separated into pieces corresponding to the respective storing portions 12.

### EXPLANATION OF SYMBOLS

10, 110, 210: PTP (packaging material), 11: PTP body portion, 12: storing portion, 14: cover, 30, 30A, 130A, 230A: opening detection sheet, 32: metal layer, 33: slit, 34B: lower high adhesive layer (second adhesive layer), 36: insulating layer, 38: low adhesive layer (first adhesive layer), 40, 40A, 40B, 40C, 40D: IC, 50: release paper

1. An opening detection sheet to be attached to a packaging material, the opening detection sheet comprising:
a metal layer being releasable from the packaging material and including a slit;
an IC mounted on the metal layer so as to cover at least a portion of the slit and being for communicating with an external device;
an insulating layer disposed on an opposite side from the IC with respect to the metal layer; and
a first adhesive layer bonded to the insulating layer on an opposite side from the metal layer so as to be bonded to the packaging material.

2. The opening detection sheet according to claim 1, further comprising a second adhesive layer that has adhesive force greater than adhesive force of the first adhesive layer and is disposed between the insulating layer and the metal layer and bonded to the insulating layer.

3. The opening detection sheet according to claim 2, wherein the second adhesive layer is an adhesive agent or an adhesive tape that includes acryl-based material, urethane-based material, silicon-based material, or a rubber-based material.

4. The opening detection sheet according to claim 1, wherein the first adhesive layer is an adhesive agent or an adhesive tape that includes acryl-based material, urethane-based material, silicon-based material, or a rubber-based material.

5. The opening detection sheet according to claim 1, wherein adhesive force of the first adhesive layer with respect to the insulating layer is from 0.01 N/25 mm or greater and smaller than 10 N/25 mm.

6. The opening detection sheet according to claim 1, wherein a thickness of the insulating layer is 1 mm or greater and 2 mm or smaller.

7. The opening detection sheet according to claim 1, further comprising a release paper that is disposed on an opposite side from the insulating layer with respect to the first adhesive layer and to be released from the first adhesive layer before being attached to the packaging material such that the first adhesive layer is uncovered.

8. A packaging material comprising:
a storing portion storing an object;
a cover that is a sheet and seals the storing portion; and
the opening detection sheet according to claim 1, the opening detection sheet being attached to the cover.

9. The packaging material according to claim 8, wherein the cover includes an aluminum foil.

10. The packaging material according to claim 8, wherein
the storing portion includes storing portions, and
the slit and the IC are provided for each of the storing portions.

11. The packaging material according to claim 8, wherein the object can be taken out with the cover being pressed and broken.
